(19) United States
(12) Patent Application Publication
(10) Pub. No.: US 2017/0096144 A1
(43) Pub. Date: Apr. 6, 2017

(54) System and Method for Inspecting Road Surfaces

(71) Applicant: Ford Global Technologies, LLC, Dearborn, MI (US)

(72) Inventors: Larry Dean ELIE, Ypsilanti, MI (US); Allan Roy GALE, Livonia, MI (US)

(21) Appl. No.: 14/874,865

(22) Filed: Oct. 5, 2015

(51) Int. Cl. B60W 40/068; G06T 7/00; B60W 30/02; B60W 10/22; B60W 10/18; G06K 9/00; H04N 5/33

(52) U.S. Cl. CPC B60W 40/068; G06K 9/00791; G06T 7/0051; H04N 5/33; B60W 10/22; B60W 10/18; B60W 30/02; B60W 2420/42

(57) ABSTRACT

A vehicle includes at least one infrared source emitting light at first and second wavelengths corresponding to a water-absorption wavelength and an ice-absorption wavelength respectively. The vehicle further includes a plenoptic camera system configured to detect a backscatter intensity of the first and second wavelengths and generate a depth map that indicates water or ice on a road in response to the backscatter intensity associated with one of the wavelengths being less than a threshold intensity.

### TECHNICAL FIELD

The present disclosure relates to a system and method for inspecting road surfaces with an imaging system disposed on a vehicle. The road data captured by the imaging system can be utilized to warn the driver and/or modify active and semi-active systems of the vehicle.

### BACKGROUND

Road conditions vary greatly due to inclement weather and infrastructure. The driving experience of a motor vehicle can be improved by dynamically adapting systems of the vehicle to mitigate the effects of the road surface irregularities or whether-based issues such as ice, snow, or water. Some vehicles include active and semi-active systems (such as vehicle suspension and automatic braking systems) that may be adjusted based on road conditions.

### SUMMARY

According to one embodiment, a method of inspecting a road includes illuminating the road with at least one infrared source emitting light at first and second wavelengths corresponding to a water-absorption wavelength and an ice-absorption wavelength respectively. The method also includes monitoring the road with a plenoptic camera system. The at least one infrared source and the camera are mounted to a vehicle. The method further includes detecting a backscatter intensity of the first and second wavelengths with the camera system to create a depth map of the road that includes data indicating water or ice on the road in response to the backscatter intensity associated with one of the first and second wavelengths being less than a threshold intensity, and outputting the depth map from the camera system to a controller.

According to another embodiment, a vehicle includes at least one infrared source emitting light at first and second wavelengths corresponding to a water-absorption wavelength and an ice-absorption wavelength respectively. The vehicle further includes a plenoptic camera system configured to detect a backscatter intensity of the first and second wavelengths and generate a depth map that indicates water or ice on a road in response to the backscatter intensity associated with one of the wavelengths being less than a threshold intensity.

According to yet another embodiment, a vehicle includes at least one infrared source configured to emit light, at first and second wavelengths corresponding to a water-absorption wavelength and an ice-absorption wavelength respectively, on a road. A plenoptic camera system of the vehicle is aimed at the road and is configured to detect a backscatter of the first and second wavelengths off the road, and generate a first depth map indicating a first topography of the road for the first wavelength and a second depth map indicating a second topography of the road for the second wavelength. A vehicle controller is configured to receive the first and second depth maps and, in response to detecting an elevation differential between the first and second topographies, output a signal indicating ice at a location on the road where the second topography has an elevation greater than the first topography.

### BRIEF DESCRIPTION OF THE DRAWINGS

FIG. 1 is a schematic diagram of a vehicle driving on a road.

FIG. 2 is a schematic diagram of a plenoptic camera.

FIG. 3 is a flowchart for generating an enhanced depth map.

FIG. 4 illustrates a flow chart for controlling a suspension system, an antilock-braking system, and a stability-control system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

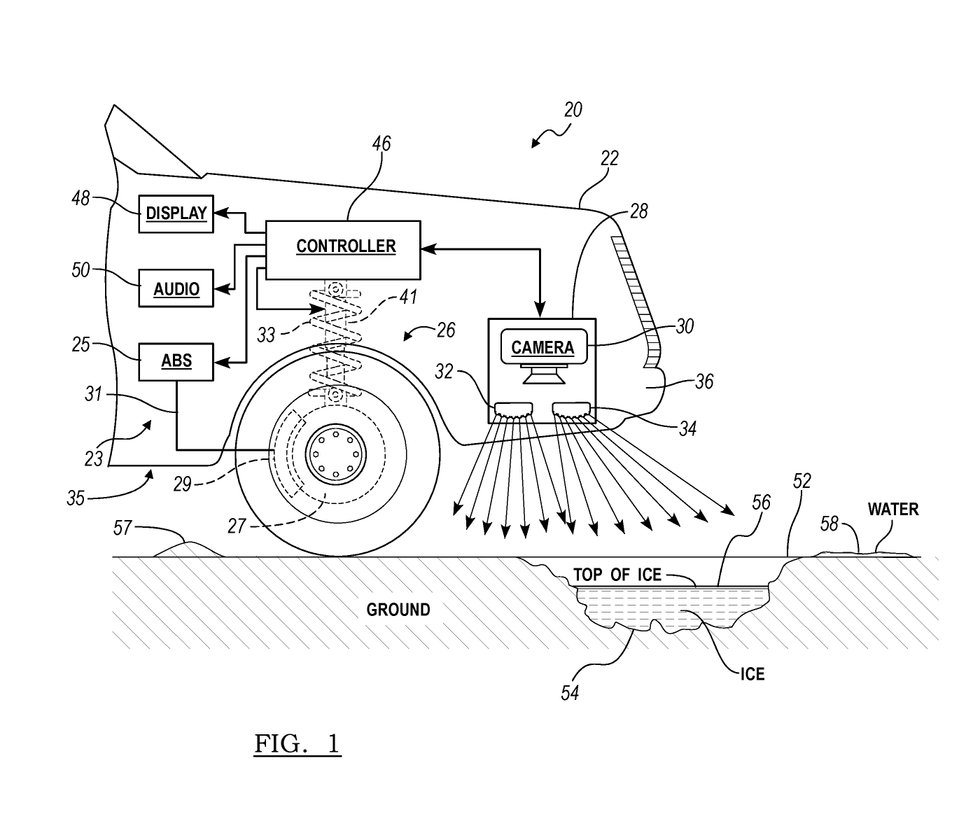

Referring to FIG. 1, a vehicle 20 includes a body structure 22 supported by a chassis. Wheels 24 are connected to the chassis via a suspension system 26 including at least springs 33, dampeners 41, and linkages. The vehicle also includes an anti-lock braking system (ABS) 23 having at least a master cylinder, disks 27 (or drums), calipers 29, a valve-and-pump housing 25, brake lines 31, and wheel sensors (not shown). The vehicle also includes a steering system including a steering wheel fixed on a steering shaft that is connected to a steering rack (or steering box) that is connected to the front wheels via tie rods or other linkages. A sensor may be disposed on the steering shaft to determine a steering angle of the system. The sensor is in electrical communication with the controller 46 and is configured to output a single indicative of the steering angle.

The vehicle 20 includes a vision system 28 attached to the body structure 22 (such as the front bumper). The vision system 28 includes a plenoptic camera 30 (also known as a light-field camera, an array camera, or a 4D camera), and a first light source 32 and a second light source 34. The first and second light sources 32, 34 may be near infrared (IR) light-emitting diodes (LED). The vision system 28 may be located on an underside 35 of a front end 36 of the vehicle 20. The camera 30 and light sources 32, 34 are pointed downwardly at the road in order to inspect the road. The vision system may be pointed directly down at the road or may be pointed at an forward angle between 0° (i.e. straight down) and 45°. In one embodiment, the light sources 32, 34 are aimed at the road at a location disposed within a footprint of the underside 35 of the vehicle 20. By doing this, the inspected area is shaded from ambient light (e.g. sunlight) by the vehicle, which may increase the accuracy of the vision system 28.

The vision system 28 is in electrical communication with a vehicle control system (VSC). The VCS includes one or more controllers 46 for controlling the function of various components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers. The controller 46 receives signals from the vision system 28 and includes memory containing machine-readable instructions for processing the data from the vision system 28. The controller 46 is programmed to output instructions to at least a display 48, an audio system 50, the suspension system 26, and the ABS 23.

Plenotic cameras are able to edit the focal point past the imaged scene and to move the view point within limited borderlines. Plenotic cameras are capable of generating a depth map of the field of view of the camera. A depth map provides depth estimates for pixels in an image from a reference viewpoint. The depth map is utilized to represent a spatial representation indicating the distance of objects from the camera and the distances between objects within the field of view. An example of using a light-field camera to generate a depth map is disclosed in U.S. Patent Application Publication No. 2015/0049916 by Ciurea et al., the contents of which are hereby incorporated by reference in its entirety. The camera 30 can detect, among other things, the presence of several objects in the field of view of the camera, generate a depth map based on the objects detected in the field of view of the camera 30, detect the presence of an object entering the field of view of the camera 30, detect surface variation of a road surface, and detect ice or water on the road surface.

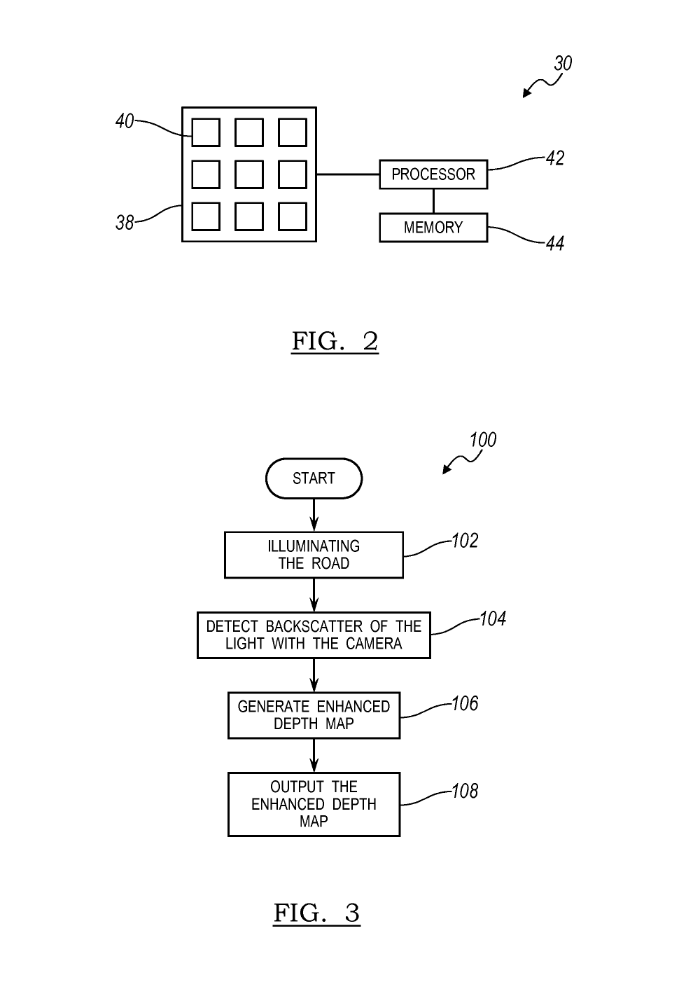

Referring to FIG. 2, the plenoptic camera 30 may include a camera module 38 having an array of imagers 40 (i.e. individual cameras) and a processor 42 configured to read out and process image data from the camera module 38 to synthesize images. The illustrated array includes 9 imagers, however, more or less imagers may be included within the camera module 38. The camera module 38 is connected with the processor 42. The processor is configured to communicate with one or more different types of memory 44 that stores image data and contains machine-readable instructions utilized by the processor to perform various processes, including generating depth maps and detecting ice or water.

Each of the imagers 40 may include a filter used to capture image data with respect to a specific portion of the light spectrum. For example, the filters may limit each of the cameras to detecting a specific spectrum of near-infrared light. In one embodiment, the array of imagers includes a first set of imagers for detecting a wavelength corresponding to a water absorption wavelength and a second set of imagers for detecting a wavelength corresponding to an ice absorption wavelength. In another embodiment, the imagers are configured to detect a range of near-IR wavelengths.

The camera module 38 may include charge collecting sensors that operate by converting the desired electromagnetic frequency into a charge proportional to the intensity of the electromagnetic frequency and the time that the sensor is exposed to the source. Charge collecting sensors, however, typically have a charge saturation point. When the sensor reaches the charge saturation point sensor damage may occur and/or information regarding the electromagnetic frequency source may be lost. To overcome potentially damaging the charge collecting sensors, a mechanism (e.g., shutter) may be used to proportionally reduce the exposure to the electromagnetic frequency source or control the amount of time the sensor is exposed to the electromagnetic frequency source. However, a trade-off is made by reducing the sensitivity of the charge collecting sensor in exchange for preventing damage to the charge collecting sensor when a mechanism is used to reduce the exposure to the electromagnetic frequency source. This reduction in sensitivity may be referred to as a reduction in the dynamic range of the charge collecting sensor, The dynamic range refers to the amount of information (bits) that may be obtained by the charge collecting sensor during a period of exposure to the electromagnetic frequency source.

Referring back to FIG. 1, the vision system 28 is able to provide information about the road surface to the driver and the vehicle in the form of an enhanced depth map. An enhanced depth map includes data indicating distance information for objects in the field of view, and includes data indicating the presence of ice or water in the field of view. The visions system 28 inspects an upcoming road segment 52 for various conditions such as potholes, bumps, surface irregularities, ice, and water. The upcoming road segment 52 may be under the front end of the vehicle, or approximately 1 to 10 meters in front of the vehicle. The vision system 28 captures images of the road segment 52, processes these images to create a depth map and outputs the depth map to the controller 46 for use by other vehicle systems.

The vision system 28 can independently detect either ice or water on the road segment 52. Water and ice have different near-infrared-absorption frequencies. The vision system 28 may include at least two near IR light sources, one that emits light at a water-absorption frequency and another that emits light at an ice-absorption frequency. The camera 30 is configured to create a first depth map based on backscattered light in the water-absorption frequency, and a second depth map based on backscattered light in the ice-absorption frequency. The first depth map indicates a first topography of the road as seen by the water-absorption frequency. The second depth map indicates a second topography of the road as seem by ice-absorption frequency. Due to varying properties of the frequencies, the first and second topographies of an exact same road may be different if water or ice is present on the road. Elevation differentials between the first and second topographies can be utilized to determine at least the presence of ice or water on the road, if potholes are filled with ice or water, and the depth of a pothole filled with ice or water.

The visions system 28 images the road and outputs the first and second depth maps to the controller 46. The controller 46 processes the depth maps to determine information of the road for use by one or more vehicle systems, such as the suspension and braking systems. For example, a road includes a pothole filled partially filled with water. The water-absorption frequency will image the top of the road (where water is not present) and will image the top of the water in the pothole, which will image as a slightly dark patch. Thus, the first depth map will incorrectly indicate that the bottom of the pot hole is at the top of the water because the water-absorption wavelength is not able to penetrate the water to image the true bottom of the pothole. But, the ice-absorption wavelength will penetrate the water and image the true bottom of the pothole. Thus, the first and second topographies will have an elevation differential to the pothole. The controller 46 is programmed to detect and compare these elevation differentials and, in response to a detected elevation differential, output a signal indicating ice or water on the road. The controller is also programmed to synthesis the first and second depth maps to produce a true picture of the road surface. For example, the controller can determine that if it is ice or water by determining which depth map has the higher elevation at points of elevation differential. In the example above, the first depth map has a higher elevation at the pothole than the second depth map, thus the controller is able to determine that the substance is water. Using the second depth map, the controller is also able to determine the true bottom of the pothole and output this information to vehicle systems. A similar process may be performed to determine the presence of ice. For example, if the road included a pothole filled with ice, the controller may use the methodology explained above to determine, the presence of ice, the top of the ice, and the bottom of the pothole.

In an alternative embodiment, the vision system may include a third light source that emits light at a third wavelength (such as 875 nanometers). The camera is configured to generate and output a third depth map for the third wavelength. The third wavelength is able to see through both water and ice. Inclusion of the third light source allows for the detection of ice over water, or water over ice. For example, a road includes a pothole filled with a layer of water towards the bottom and a layer of ice on top. The first depth map can detect the top of the water, the second depth map can detect the top of the ice, and the third depth map can detect the bottom of the pothole.

In another embodiment, the vision system 28 can also detect ice or water on the road segment 52 by detecting intensities of the backscatter off the road. Water can be detected by emitting light at a water-absorption wavelength and measuring the backscattering of the light with the camera 30. Light at the water-absorption wavelength is absorbed by the water and generally does not reflect back to the camera 30. Thus, water can be detected by measuring the intensity of light detected by the camera 30. The camera includes software that compares the received intensity of light to a threshold value and, if the received intensity of light is below the threshold value, the camera determines the presence of water on the road. Similarly, ice can be detected by emitting light at an ice-absorption wavelength and measuring the backscattering of the light with the camera 30. Light at the ice-absorption wavelength is absorbed by the ice and generally does not reflect back to the camera 30. Thus, ice can be detected by measuring the intensity of light detected by the camera 30. The camera includes software that compares the received intensity of light to a threshold value and, if the received intensity of light is below the threshold value, the camera determines the presence of ice on the road.

In the illustrated example, the vision system includes a first light source 32 and a second light source 34. Other embodiment may only use a single light source. The first light source 32 may emit light at a water-absorption wavelength, and the second light source 34 may emit light at an ice-absorption wavelength. The wavelengths may be in the near-IR spectrum so that the light is invisible or almost invisible to humans. Water-absorption IR wavelengths include 970, 1200, 1450, and 1950 nanometers (nm) and ice-absorption wavelengths include 1620, 3220, and 3500 nm. The first and second light sources 32, 34 are aimed at the road and illuminate the road surface with the water-absorption and the ice-absorption wavelengths. The camera 30 is also aimed at the road to detect the backscattered light from the light sources.

In the illustrated embodiment, the upcoming road segment 52 includes a pothole 54 partially filled with ice 56, and a puddle of a water 58. The vision system 28 is able to create an enhanced depth map including information about the location, size, and depth of the pothole 54 and indicating the presence of the ice 56 and water 58. The depth map indicates both the bottom of the pothole beneath the ice and the top of the ice. The vision system 28 utilizes the first light source 34 to detect the ice. The light from the first light source is mostly absorbed by the ice: the camera detects the low intensity of that light and determines that ice is present. A portion of the light source 32 reflects off the top of the ice and a portion transmits through the ice and reflects back off the bottom of the pothole 54. The vision system 28 utilizes this to determine the bottom of the pothole 54 and the top of the ice 56.

The controller may use other sensor data to verify the ice reading. For example, the controller can check an outside air temperature when ice is detected. If the air temperature is above freezing by a predetermined amount, then the controller knows the ice reading is false. The vehicle is periodically (e.g. every 100 milliseconds) generating a depth map. Previous depth maps can be used to verify the accuracy of a newer depth map.

The vehicle may utilize the first light source 32 in a similar manner to determine the presence of water on the road segment 52. For example, as the vehicle 20 travels over (or nears) the water 58, the camera 30 will detect the water due to the low intensity of detected light from the first light source. Light from the second light source 34 is able to penetrate through the water allowing the camera to detect the road surface beneath the water.

The vehicle was also able to detect the bump 57 on the road surface using the camera 30. The camera 30 is configured to output a depth map to the controller 46 that includes information about the bump 57. This information can then be used to modify vehicle components.

In some embodiments, the processor 42 processes the raw data from the images and creates the enhanced depth map. The processor 42 then sends the enhanced depth map to the controller 46. The controller 46 uses the depth map to control other vehicle systems. For example, this information can be used to warn the driver via the display 48 and/or the audio system 50, and can be used to adjust the suspension system 26, the ABS 23, the traction-control system, the stability-control system, or other active or semi-active systems.

The suspension system 26 may be an active or semi-active suspension system having adjustable ride height and/or dampening rates. In one example, the suspension system includes electromagnetic and magneto-rheological dampeners 41 filled with a fluid whose properties can be controlled by a magnetic field. The suspension system 26 is controlled by the controller 46. Using the enhanced depth map received from the vision system 28, the controller 46 can modify the suspension 26 to improve the ride of the vehicle. For example, the vision system 28 can detect the pothole 54 and the controller 46 can instruct the suspension to adjust accordingly to increase ride quality over the pothole. The suspension system 26 may have an adjustable ride height and each wheel may be individually raised or lowed. The system 26 may include one or more sensor for providing feedback signals to the controller 46.

In another example, the suspension system 26 is an air-suspension system including at least air bellows and a compressor that pumps air into (or out of) the air bellows to adjust the ride height and stiffness of the suspension. The air system is controlled by the controller 46 such that the air suspension may be dynamically modified based on road conditions (e.g. the depth map) and driver inputs.

The vehicle also includes ABS 23. Typical anti-lock braking systems sense wheel lockup with a wheel sensor. Data from the wheel sensors are used by the valve-and-pump housing to reduce (or eliminate) hydraulic pressure to the sliding wheel (or wheels) allowing the tire to turn and regain traction with the road. These systems typically do not engage until one or more of the wheels have locked-up and slide on the road. It is advantageous to anticipate a lockup condition prior to lockup actually occurring. The vision system 28 (and particular the ice and water data of the enhanced depth map) can be used to anticipate a sliding condition prior to any of the wheels actually locking up. For example, if the enhanced depth map indicates an ice patch in a path of one or more of the wheels, the ABS 23 can be modified ahead of time to increase braking effectiveness on the ice. The controller 46 (or another vehicle controller) may include algorithms and lookup tables containing strategies for braking on ice, water, snow, and other surface conditions.

Moreover, if the surface-coefficient of friction (u) is known, the controller can modulate the braking force accordingly to optimize braking performance. For example, the controller can be programmed to provide wheel slip, between the wheels and the road, of approximately 8% during braking to decrease stopping distance. The wheel slip is a function of u, which is a dependent upon the road surface. The controller can be preprogrammed with u values for pavement, dirt, ice, water, snow, and surface roughness (e.g. potholes, broken pavement, loose gravel, ruts, etc.) The enhanced depth map can identify road conditions allowing the controller 46 to select the appropriate u values for calculating the braking force. Thus, the controller 46 may command different braking forces for different road-surface conditions.

The vehicle 20 may also include a stability-control system that attempts to the keep the angular momentum of the vehicle below a threshold value. The vehicle 20 may include yaw sensors, torque sensors, steering-angle sensors, and ABS sensors (among others) that provide inputs for the stability-control system. If the vehicle determines that the current angular momentum exceeds the threshold value, the controller 46 intervenes and may modulate braking force and engine torque to prevent loss of control. The threshold value is a function of u and the road surface smoothness. For example, on ice, a lower angular momentum can result in a loss of vehicle control than on dry pavement, which requires a higher angular momentum to result in a loss of vehicle control. Thus, the controller 46 may be preprogrammed with a plurality of different angular-momentum threshold values for different detected road surfaces. The information provided by the enhanced depth map may be used by the controller to choose the appropriate angular-momentum threshold value to apply in certain situations. Thus, if ice is detected, for example, the stability-control system may intervene sooner than if the vehicle is on dry pavement. Similarly, if the depth map detects broken pavement the controller 46 may apply a lower threshold value than for smooth pavement.

FIG. 3 illustrates a flow chart 100 for generating an enhanced depth map. At operation 102 the vision system illuminates a segment of the road with at least one infrared source emitting light at first and second wavelengths corresponding to a water-absorption wavelength and an ice-absorption wavelength respectively. A plenoptic camera monitors the road segment and detects the backscatter of the emitted light at operation 104. At operation 106 the plenoptic camera generates an enhanced depth map. At operation 108 the plenoptic camera outputs the enhanced depth map to one or more vehicle controllers. In some embodiments, the camera system may be programmed to determine if one or more of the lens of the camera are dirty or otherwise obstructed. Dirty or obstructed lens may cause false objects to appear in the images captured by the camera. The camera system may determine that one or more lens are dirty by determining if an object is only detected by one or a few lens. If so, the camera systems flags those lens as dirty and ignores data from those lens. The vehicle may also warn the driver that the camera is dirty or obstructed.

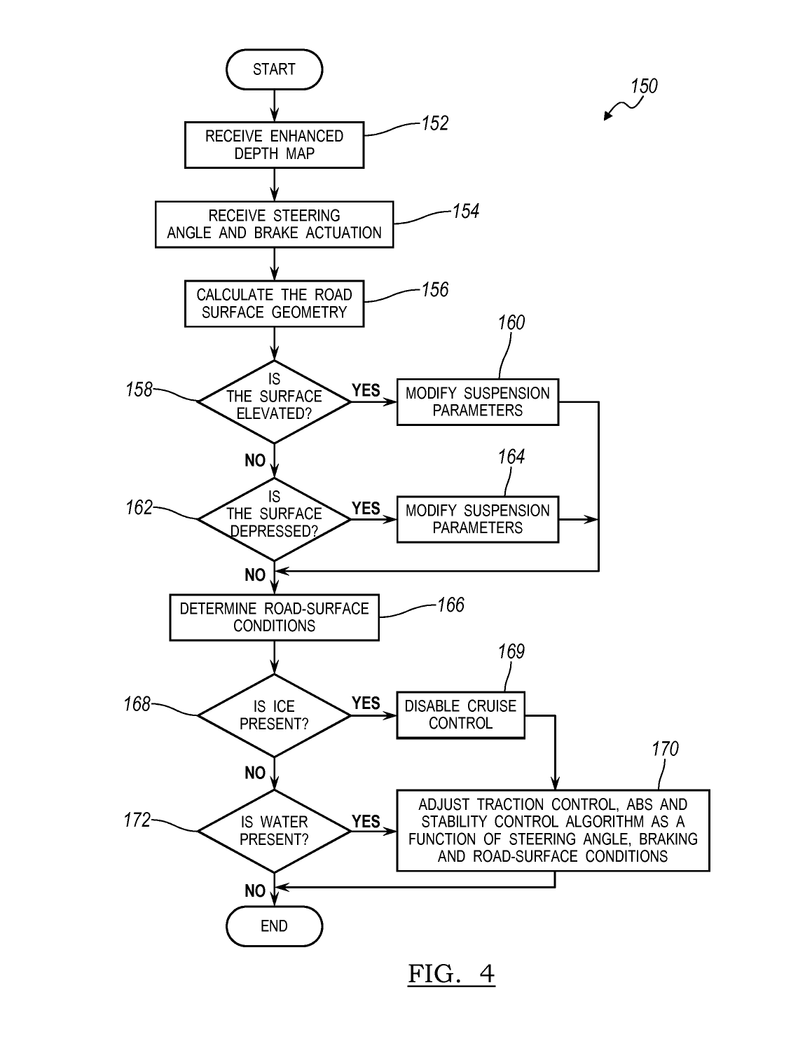

FIG. 4 illustrates a flow chart 150 for controlling the active and semi-active vehicle systems. At step 152 the controller receives the enhanced depth map from the camera system. At step 154 the controller receives sensor data from various vehicle sensors such as the steering angle and the brake actuation. At step 156 the controller calculates the road surface geometry using information from the enhanced that map. At operation 158 the controller determines if the road surface is elevated by evaluating the depth map for bumps. If an elevated surface is detected in the depth map, control passes to operation 160 and the vehicle identifies the affected wheels and modifies the suspension and/or the braking force (depending on current driving conditions) to improve driving dynamics. For example, if a bump is detected, the affected wheel may be raised by changing the suspension ride height for that wheel and/or the suspension stiffness may be softened to reduce shutter felt by the driver. If at operation 158 the surface is not elevated, control passes to operation 162 and the controller determines if the road surface is depressed. If the road surface is depressed, suspension parameters are modified to increase vehicle ride quality over the depression. For example, if a pothole is detected, the affected wheel may be raised by changing the suspension ride height for that wheel and/or the suspension stiffness may be softened to reduce shutter felt by the driver. At operation 166, the controller calculates determines road-surface conditions using information from the enhanced depth map and other vehicle sensors. For example the controller may determine if the road is paved or gravel, and may determine if water or ice is present on the road surface. At operation 168 the controller determines if ice is present on the road using the enhanced depth map.

If ice is present, control passes to operation 169 and the cruise control is disabled. Next, control passed to operation 170 and the controller adjusts the traction-control system, the ABS and the stability-control system to increase vehicle performance on the icy surface. These adjustments may be based on a function of the steering angle, the current braking, and the road-surface conditions. If ice is not detected, control passes to operation 172 and the controller determines if water is present. If water is present, control passes to operation 170 where the traction control, ABS and stability control are modified based on the presence of the water.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of inspecting a road comprising:
illuminating the road with at least one infrared source emitting light at first and second wavelengths corresponding to a water-absorption wavelength and an ice-absorption wavelength respectively;
monitoring the road with a plenoptic camera system, wherein the at least one infrared source and the camera are mounted to a vehicle;
detecting a backscatter intensity of the first and second wavelengths with the camera system to create a depth map of the road that includes data indicating water or ice on the road in response to the backscatter intensity associated with one of the first and second wavelengths being less than a threshold intensity; and
outputting the depth map from the camera system to a controller.

2. The method of claim 1 wherein the at least one infrared source includes a first infrared source emitting light at the first wavelength, and a second infrared source emitting light at the second wavelength.

3. The method of claim 2 wherein the first and second infrared sources are light emitting diodes (LEDs).

4. The method of claim 1 wherein the second wavelength is between 1615 to 1625 nanometers (nm) inclusive, and the first wavelength is between one of 965 to 975 nm inclusive, 1195 to 1205 nm inclusive, 1445 to 1455 nm inclusive, and 1945 to 1955 nm inclusive.

5. The method of claim 1 further comprising modifying a state of a suspension of the vehicle based on the depth map.

6. The method of claim 1 further comprising, in response to the depth map indicating water or ice, modifying a state of a braking system of the vehicle.

7. The method of claim 1 further comprising, in response to the depth map indicating water or ice, reduce an angular-momentum threshold for engaging a stability-control system.

8. A vehicle comprising:
at least one infrared source emitting light at first and second wavelengths corresponding to a water-absorption wavelength and an ice-absorption wavelength respectively; and
a plenoptic camera system configured to detect a backscatter intensity of the first and second wavelengths and generate a depth map that indicates water or ice on a road in response to the backscatter intensity associated with one of the wavelengths being less than a threshold intensity.

9. The vehicle of claim 8 wherein the at least one infrared source includes a first infrared source emitting light at the first wavelength, and a second infrared source emitting light at the second wavelength.

10. The vehicle of claim 9 wherein the first and second infrared sources are light emitting diodes (LEDs).

11. The vehicle of claim 8 further comprising an underside, wherein the least one infrared source, and the plenoptic camera are mounted to the underside.

12. The vehicle of claim 11 wherein the least one infrared source is aimed at the road such that the first and second wavelengths illuminate the road at a location disposed within a footprint of the underside.

13. The vehicle of claim 8 further comprising a controller configured to receive the depth map and, in response to the depth map indicating ice or water, modify a state of a suspension of the vehicle.

14. The vehicle of claim 8 further comprising a controller configured to receive the depth map and, in response to the depth map indicating ice or water, modify a state of a braking system of the vehicle.

15. The vehicle of claim 9 wherein the second wavelength is between 1615 to 1625 nanometers (nm) inclusive, and the first wavelength is between one of 965 to 975 nm inclusive, 1195 to 1205 nm inclusive, 1445 to 1455 nm inclusive, and 1945 to 1955 nm inclusive.

16. A vehicle comprising:
at least one infrared source configured to emit light at first and second wavelengths corresponding to a water-absorption wavelength and an ice-absorption wavelength respectively on a road;
a plenoptic camera system aimed at the road and configured to detect a backscatter of the first and second wavelengths off the road and generate a first depth map indicating a first topography of the road for the first wavelength and a second depth map indicating a second topography of the road for the second wavelength; and
a controller configured to receive the first and second depth maps and, in response to detecting an elevation differential between the first and second topographies, output a signal indicating ice at a location on the road where the second topography has an elevation greater than the first topography.

17. The vehicle of claim 16 wherein the controller is further configured to output a signal indicating water at a location on the road where the first topography has an elevation greater than the second topography.

18. The vehicle of claim 16 wherein the at least one infrared source is a first infrared source emitting light at the first wavelength, and a second infrared source emitting light at the second wavelength.

19. The vehicle of claim 16 wherein the second wavelength is between 1615 to 1625 nanometers (nm) inclusive, and the first wavelength is between one of 965 to 975 nm inclusive, 1195 to 1205 nm inclusive, 1445 to 1455 nm inclusive, and 1945 to 1955 nm inclusive.

20. The vehicle of claim 16 wherein the least one infrared source and the plenoptic camera system are mounted to an underside of the vehicle, and wherein the least one infrared source is aimed at the road such that the first and second wavelengths illuminate the road at a location disposed within a footprint of the underside.
